(19) United States
(12) Patent Application Publication
(10) Pub. No.: US 2018/0043876 A1
(43) Pub. Date: Feb. 15, 2018

(54) BRAKE-BY-WIRE SYSTEM

(71) Applicant: GM Global Technology Operations LLC, Detroit, MI (US)

(72) Inventors: Alan J. Houtman, Milford, MI (US); Paul A. Kilmurray, Wixom, MI (US); Brandon C. Pennala, Howell, MI (US); Christopher C. Chappell, Commerce Township, MI (US)

(21) Appl. No.: 15/234,747

(22) Filed: Aug. 11, 2016

(51) Int. Cl. B60T 17/22

(52) U.S. Cl. CPC B60T 17/221; B60T 2270/82

(57) ABSTRACT

A vehicle is provided. The vehicle includes a brake-by-wire sub-system, which includes a controller. The controller receives a request to enter a service mode. In response to the request to enter the service mode, the controller determines whether a vehicle is in a stable state based on comparing at least one system condition against at least one threshold. When the vehicle is in the stable state, the controller causes the brake-by-wire sub-system to enter into the service mode. Further, the controller monitors the at least one system condition against predefined parameters to determine that the vehicle is maintaining the stable state while in the service mode.

### FIELD OF THE INVENTION

The invention disclosed herein relates to a vehicle having a brake-by-wire system including a service mode mechanism.

### BACKGROUND

Conventional braking systems of a vehicle include mechanical and/or hydraulic braking systems that provide direct mechanical linkages and/or hydraulic force-transmitting-paths between an operator and brake control units of the vehicle. Conventional braking systems also add a significant weight penalty to the vehicle itself. Thus, reducing or replacing the conventional braking systems is desirable.

Current industrial trends include reducing a number of overall mechanical components and an overall weight of the vehicle through system-by-wire applications, also referred to as X-by-wire systems. One such X-by-wire system is a brake-by-wire system, which is sometimes referred to as an electronic braking system (EBS). Present implementations of brake-by-wire systems may not include electrical redundancy vs mechanical redundancy (e.g., duplication of hardware and/or software to account for component failures), fault tolerance (e.g., overcoming undesired events affecting control signals, data, hardware, software or other elements of such systems), fault monitoring (e.g., detecting undesired events), and other security mechanism to ensure proper braking.

### SUMMARY OF THE INVENTION

In one exemplary embodiment, a vehicle system of a vehicle is provided. The vehicle system includes a brake-by-wire sub-system, which includes a controller. The controller receives a request to enter a service mode. In response to the request to enter the service mode, the controller determines whether a vehicle is in a stable state based on comparing at least one system condition against at least one threshold. When the vehicle is in the stable state, the controller causes the brake-by-wire sub-system to enter into the service mode. Further, the controller monitors the at least one system condition against predefined parameters to determine that the vehicle is maintaining the stable state while in the service mode.

In another exemplary embodiment, a method by a controller of a brake-by-wire system of a vehicle is provided. The method comprises receiving a request to enter a service mode. In response to the request to enter the service mode, the method comprises determining whether the vehicle is in a stable state based on comparing at least one system condition against at least one threshold, causing the vehicle to enter into the service mode when the vehicle is in the stable state, and monitoring the at least one system condition against predefined parameters to determine that the vehicle is maintaining the stable state while in the service mode.

The above features and advantages are readily apparent from the following detailed description when taken in connection with the accompanying drawings and claims.

### BRIEF DESCRIPTION OF THE DRAWINGS

Other features, advantages and details appear, by way of example only, in the following detailed description of embodiments, the detailed description referring to the drawings in which:

FIG. 1 is a top schematic view of a vehicle having a brake-by-wire system in accordance with an embodiment;

FIG. 2 is a top schematic view of a brake-by-wire system in accordance with an embodiment;

FIG. 3 is a brake-by-wire system in accordance with an embodiment;

FIG. 4 is a process flow executed by a service mode mechanism of a brake-by-wire system in accordance with an embodiment;

FIG. 5 is a schematic view of a service mode mechanism of a brake-by-wire system in accordance with an embodiment; and

FIG. 6 is a process flow executed by a service mode mechanism of a brake-by-wire system in accordance with another embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

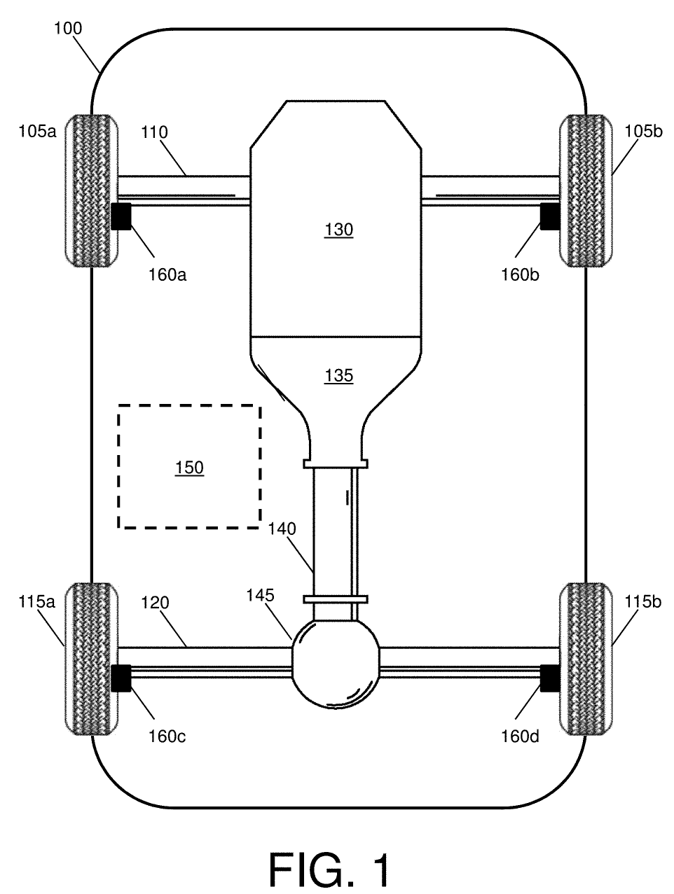

In accordance with an embodiment, FIG. 1 is a top schematic view of a vehicle 100. As illustrated in FIG. 1, the vehicle 100 includes a first wheel pair 105 (e.g., a wheel 105a and a wheel 105b), a first axle 110, a second wheel pair 115 (e.g., a wheel 115a and a wheel 115b), a second axle 120, an engine 130, a transmission 135, a driveshaft 140, a differential assembly 145, a brake-by-wire system 150, and a plurality of brake assemblies 160a-d.

The vehicle 100 may be any automobile, truck, van, sport utility vehicle, or the like. As used herein, the term vehicle is not limited to just an automobile, truck, van, or sport utility vehicle, but may also include any self-propelled or towed conveyance suitable for transporting a burden. Thus, it should be appreciated that the brake-by-wire system 150 described herein may be used with any type of vehicle.

The vehicle 100 may include an engine 130, such as a gasoline or diesel fueled internal combustion engine. The engine 130 may further be a hybrid type engine that combines an internal combustion engine with an electric motor. The engine 130 may also be entirely electric. The engine 130 can be coupled to a frame or other chassis structure of the vehicle 100.

The vehicle 100 may include the first wheel pair 105 arranged adjacent the engine 130 (and connected via a transmission, a driveshaft, a differential assembly, etc., each of which is not shown for simplicity). The engine 130 can also be coupled to the second wheel pair 115 through the transmission 135, the driveshaft 140, and the differential assembly 145. The wheels 105a, 105b, 115a, 115b can be configured to receive outputs from the engine 130 individually, as pairs, or in conjunction with one another.

For example, when the engine 130 is engaged with one or both of the first wheels (105a and 105b), the vehicle 100 may be said to include a front-wheel drive configuration. When the engine 130 is engaged with one or both of the second wheels (115a and 115b), the vehicle 100 may be said to include a rear-wheel drive configuration. When the engine 130 is simultaneously engaged with both the first wheel pair 105 and the second wheel pair 115, the vehicle 100 may be said to include a four-wheel or an all-wheel drive configuration.

The transmission 135 may be configured to reduce a rotational velocity and increase a torque output of the engine 130. In an embodiment, a modified output can then be transmitted to the differential assembly 145 via the driveshaft 140. The differential assembly 145 transmits the output torque from the driveshaft 140 through a differential gear set to the second wheel pair 115 via the second axle 120. The differential gear set is arranged within the differential assembly 145.

The vehicle 100 includes the brake-by-wire system 150 (or sub-system) and at least one of the brake assemblies 160a-d. The brake-by-wire system 150 can be an exclusive-by-wire-system that enables braking torque to the wheels (105a, 105b, 115a, and 115b). Each of the brake assemblies 160a-d can be a device for applying braking torque to the wheels (105a, 105b, 115a, and 115b) to slow or stop a motion of the vehicle 100, such as by contact friction, magnetic operation, etc.

The brake-by-wire system 150 can include one or more components, such as electrical motors, actuators, driver interface devices, emulators, isolators, power electronics, control electronics, modules, drivers, and the brake assemblies 160a-d. The components can be electronically coupled and located throughout the vehicle 100.

For example, the brake-by-wire system 150 can utilize and distribute electrical power from power electronics, such as battery sub-systems of the vehicle 100 or the brake-by-wire system 150 to the components therein. Further, the brake-by-wire system 150 can also include driver interface devices, such as a brake pedal, a parking brake lever, an input button/dial/lever, etc. Each of the driver interface devices can cause the direct application of braking torque (e.g., amount of clamping force) to the wheels (105a, 105b, 115a, and 115b), provide an electrical boost to mechanical and/or hydraulic braking systems, and/or support braking when there is no way to generate braking torque from the application of the brake pedal. Thus, the brake-by-wire system 150 can forgo, supplement, assist, or include a mechanical back-up.

In an embodiment, the plurality of brake assemblies 160a-d can be physically and/or electrically connected by electrical conductors (e.g., wires) to the brake-by-wire system 150, and thus can be considered included therein. Each of the plurality of brake assemblies 160a-d can be referred to as a brake corner, a brake assembly, a caliper/rotor assembly, etc. In general, a brake corner can include a caliper, a rotor, an isolator, a driver, and an actuator, where the actuator applies a clamping force from the caliper to the rotor based on a deceleration signal received through the isolator and the driver. Thus, each of the plurality of brake assemblies 160a-d can be configured to selectively slow the rotation of an associated wheel (105a, 105b, 115a, or 115b).

Each of the plurality of brake assemblies 160a-d can be configured to respond, whether independently or in concert, to a deceleration action from the brake-by-wire system 150. For instance, by applying braking torque to a brake pedal, activating a parking brake, operating an input button or lever, etc., an operator of a vehicle causes a deceleration signal to be sent from the brake-by-wire system 150 to the plurality of brake assemblies 160a-d.

With respect to the brake pedal, force and travel sensors can be coupled to the brake pedal to detect elements of a clamping force and/or calculate an amount of the clamping force. The clamping force can be translated by the brake-by-wire system 150 into the deceleration signal. A sensor is any converter that measures physical quantities and converts these physical quantities into a signal (e.g., raw sensor data, such as voltage in analog form; also referred to as analog sensor data). Thus, a sensor can be any device configured to detect status/condition information of mechanical machinery of the vehicle 100 of FIG. 1 and/or control electronics of the vehicle 100 of FIG. 1 and produce the analog sensor data. Examples of sensors include, but are not limited to, strain gauges that measure the physical stress or force applied (e.g., fiber optic gauges, foil gauges, capacitive gauges, etc.); travel sensors that measure movement (e.g., accelerometers, gyroscopes, etc.); and temperature sensors that measure the temperature characteristics and/or the physical change in temperature (e.g., fiber optic temperature sensors, heat meters, infrared thermometers, liquid crystal thermometers, resistance thermometers, temperature strips, thermistors, thermocouples, etc.).

With respect to the parking brake, a travel sensor can be coupled to the parking brake to detect an on-position that is translated by the brake-by-wire system 150, which in this case can indicate a predetermined clamping force that provides a full stop. The input button/dial/lever can also operate to receive an input from the operator to enable the brake-by-wire system 150 to generate, as the deceleration signal, a predetermined and/or variable clamping force. The deceleration signal causes the plurality of brake assemblies 160a-d, whether individually or in concert, to apply a braking torque on corresponding wheels that result in wheel rotational deceleration.

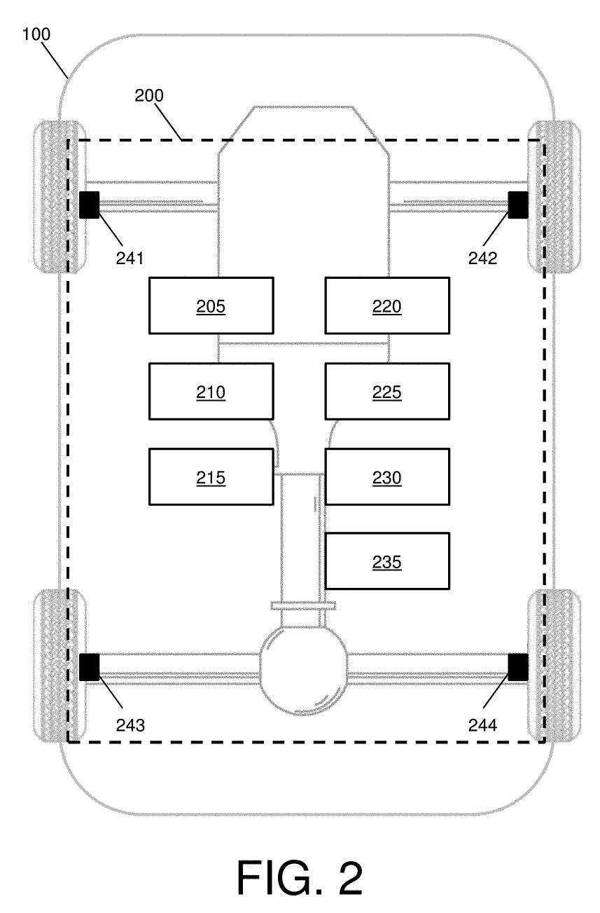

The brake-by-wire system 150 will now be described according to an embodiment and with reference to FIG. 2. As illustrated, the brake-by-wire system 150 can be embodied as a system 200. The system 200 can include a controller 205, an actuator 210, a driver interface device 215, an isolator 220, a driver 225, power electronics 230, a module 235, a first brake 241, a second brake 242, a third brake 243, and a fourth brake 244. The components of the system 200 can be electronically coupled and located throughout the vehicle 100 of FIG. 1, along with being configured to communicate/interact with each other. While single items are illustrated by FIG. 2 for each component of the system 200, these representations are not intended to be limiting and thus, the each component may represent a plurality of that component. It should be appreciated that the system 200 can include other components used in the operation of the vehicle 100 of FIG. 1, that the system 200 may also include fewer modules, that the components can be embodied in separate arrangements in a distributed manner, and that the components can be an integrated control scheme.

The system 200 can be referred to as a control system of the brake-by-wire system 150. The system 200 can, via input/output (I/O) interfaces, receive inputs, such as operator input from the driver interface device 215 and environmental inputs from sensors of the vehicle 100 of FIG. 1. The I/O interfaces can include any physical and/or virtual mechanisms utilized by the system 200 to communicate between components internal and/or external to the system 200 (e.g., the I/O interfaces can be configured to receive or send signals or data within or for the system 200). The inputs are processed by the controller 205.

The controller 205 can generate commands and/or currents to drive the actuator 210. In general, the controller 205 receives a signal from the driver interface device 215, processes the signal, and generates a command to the driver 225 based on the processed signal (e.g., the driver in turn communicates with the actuator 210, which operates one or more of the brakes 241-244). In another embodiment, the sensors detect travel/force/etc. imparted by an operator of the vehicle 100 of FIG. 1 when commanding deceleration. The travel/force/etc. signals are used to determine an amount of deceleration (e.g., a clamping force). The driver 225 communicates the amount of deceleration with the driver interface device 215, which is further communicated to the actuators 210 and actually applied to the brakes 241-244 at the wheels.

The controller 205 includes any processing hardware, software, or combination of hardware and software utilized by the system 200 that carries out computer readable program instructions by performing arithmetical, logical, and/or input/output operations. The controller 205 can include a memory (e.g., a tangible device) configured to store software and/or computer readable program instructions. Examples of the controller 205 include, but are not limited to, an arithmetic logic unit, which performs arithmetic and logical operations; a control unit, which extracts, decodes, and executes instructions from a memory; and an array unit, which utilizes multiple parallel computing elements. Other examples of the controller include an electronic control module/unit/controller, electronic parking brake module, and an application specific integrated circuit. In an embodiment, the system 200 can include two or more controllers 205 to meet requirements of power assist failures, such that if a first controller fails then a second or subsequent controller 205 continues operation.

The actuator 210 can be any type of motor that converts energy into motion, thereby controlling the movement of a mechanism, such as the brakes 241-244, based on received signals. Thus, the actuator 210 can be a direct current motor configured to generate electro-hydraulic braking torque to the corner (e.g., the brake corner, the brake assembly, the caliper/rotor assembly, etc.). The driver interface device 215 can be any combination of hardware and software that enables a component of the system 200 to behave like a component not included in, or replaced by, the system 200. For example, the driver interface device 215 can be a pedal emulator that behaves like a mechanical pedal of a hydraulic braking system. The isolator 220 can be device that transmits signals (e.g., microwave or radio frequency power) in one direction only and shields components on an input side, from the effects of conditions on an output side.

The driver 225 can be a device that transmits signals based on commands of the controller 205 to the actuator 210. The driver 225, like the controller 205, can include any processing hardware, software, or combination of hardware and software utilized by the system 200 that carries out computer readable program instructions by performing arithmetical, logical, and/or input/output operations. The driver 225 can include a memory (e.g., a tangible device) configured to store software and/or computer readable program instructions.

The power electronics 230 can control and manage electrical power throughout the system 200 and vehicle 100 of FIG. 1. The power electronics 230 can include, but are not limited to, batteries, fuses, semi-conductor based devices that are able to switch quantities of power, rectification devices, AC-to-DC conversion devices, and DC-to-AC conversion devices. The power electronics 230 can include or be in communication with first and secondary power sources to operate the system 200. For example, the first power source can be a primary 12 volt system that provides all power to run engine 130 of FIG. 1 etc., and the secondary power source can be a battery that powers the vehicle 100 of FIG. 1 when the primary power source fails.

The module 235 can include any processing hardware, software, or combination of hardware and software utilized by the system 200 to receive and respond to signals within the system. The module 235 can be embodied within the controller 205 as hardware and/or computer readable program instructions stored on a memory of the controller. Thus, in an embodiment, the controller 205 can be referred to as an electronic brake controller that includes a plurality of modules 235 (e.g., sub-components), such as an electronic parking brake module and a brake assist module.

In an embodiment, the electronic parking brake module transmits a signal to a plurality of actuators 210 causing brake calipers of the brakes 241-244 to clamp rotors with the desired amount of clamping force. This transmitted signal can include a clamping force, which in this case can indicate a predetermined clamping force that provides a full stop.

The brake assist module can determine parameters associated with deceleration actions and determine if assistance should be provided to aid braking and how much assistance is to be applied. The brake assist module can send a signal to an engine control module to request that an engine reduce the power output, which will aid in decelerating the vehicle 100.

The brake assist module further monitors the operation of the vehicle 100 of FIG. 1, such as via the brake apply sensors (e.g., brake pedal travel and brake pedal force) and the wheel speed sensors. In the event that the brake assist module determines, such as via sensors that indicate the vehicle 100 of FIG. 1, the brake-by-wire system 150, or the system 200 of FIG. 2 is not operating at a desired performance level, a signal may be transmitted to the electronic parking brake module.

The brakes 241-244 are devices for slowing or stopping motion of the vehicle 100 of FIG. 1. Each of the brakes 241-244 can be referred to as a brake assembly, brake corner, brake assembly, a caliper/rotor assembly, etc. Each of the brakes 241-244 can be configured to respond, whether directly or in concert, to a deceleration action from the emulator 215 and/or controller 205.

In an embodiment, an application of the brake-by-wire system 150 can be adjusted based on the operational characteristics of the vehicle 100. For example, when the vehicle 100 of FIG. 1 is traveling at a slower speed the controller 205 can operate the actuator 210 to apply an increased amount of clamping force to a corresponding one of the brakes 241-244 at a slower rate than at a faster rate required when the vehicle 100 is travelling at a higher speed. Further, the controller 205 can monitor the wheels, determine if there is any wheel lockup, and adjust the amount of clamping force on any one of the brakes 241-244 to alleviate or prevent the lockup from occurring.

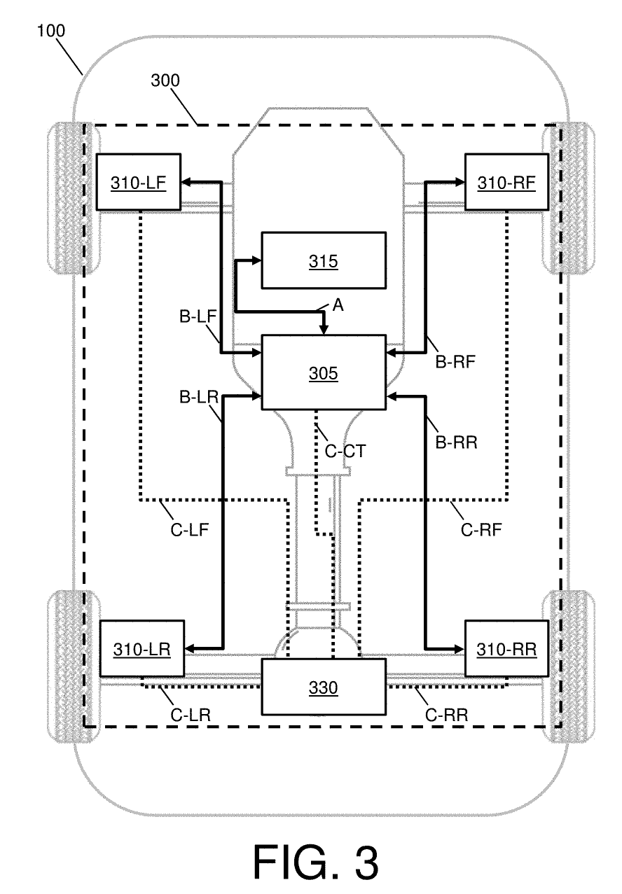

Turning now to FIG. 3, the system 200 will now be described with reference to a system 300 according to an embodiment. As illustrated, the system 300 can include a controller 305, an actuator 310, an emulator 315, and power electronics 330. The items illustrated by FIG. 3 are representations and are not intended to be limiting. Thus, each component may represent a plurality of that component and/or each plurality may represent a singular iteration thereof. It should also be appreciated that the system 300 can include other components, that the system 300 can include fewer components, that the components can be embodied in separate arrangements in a distributed manner, and that the components can be embodied in an integrated control scheme. For example, the actuator 310 is illustrated as a plurality of actuators 310 notated by the actuator 310-LF, the actuator 310-RR, the actuator 310-LR, and the actuator 310-RF, where each actuator of the plurality is aligned with and controls braking at a corresponding wheel (of a vehicle 100).

The components of the system 300 can be electronically coupled and located throughout the vehicle 100, along with being configured to communicate/interact with each other. As shown in FIG. 3, signals and power wirings are identified by various arrows and lines. The signals/communications between the controller 305 and the emulator 315 are indicated by the signal A and between the controller 305 and the actuators 310 are indicated by the signals B-LF, B-RR, B-LR, and B-RF. The power wirings C-CT, C-LF, C-RR, C-LR, and C-RF represent the coupling of the power electronics 330 and other components.

In general, the system 300 provides a braking scheme through a robust implementation of multiple components and/or algorithms that receive inputs from the emulator 315. The emulator 315 can be an electro-mechanical device that mimics a mechanical pedal of a hydraulic braking system (e.g., the emulator 315 can include a pedal assembly). The emulator 315 outputs at least one braking signal (e.g., signal A) to the controller 305.

The controller 305 can include any processing hardware, software, or combination of hardware and software utilized by the system 300 that implements architectures to achieve an operative level for the system 300. Note the controller 305 can be integrated into other controllers (e.g., such as the actuators 310 of the system 300), to reduce costs of additional hardware and/or software. The controller 305 can receive a plurality of inputs, which include inputs from the emulator 305. Further, the plurality of inputs can include engine revolutions per minute, vehicle speed, ambient temperature (e.g., in and/or outside of the vehicle), wheel speed, inertial measurements, etc. The plurality of inputs can be used by the controller 305 to generate commands and/or currents that drive the actuators 310. The commands and/or currents can be responsive to one or more of the plurality of inputs. The commands and/or currents are, in turn, braking commands by the controller 305 to the actuators 310 based on the operation of the emulator 315.

By applying pressure to a brake pedal of the pedal assembly of the emulator 315, an operator causes signal A to be sent to the controller 305. From signal A, the controller 305 can detect that a brake signal is intended by the operator and process an amount of force and a distance moved. For instance, to detect the brake signal, the electric control unit 315 can compare the amount of force and/or the distance moved to a threshold or slope. If the brake signal is detected based on this comparison, the controller 305 can generate at least one braking command to the actuators 310. Each braking command, in general, can correspond to a particular actuator 310.

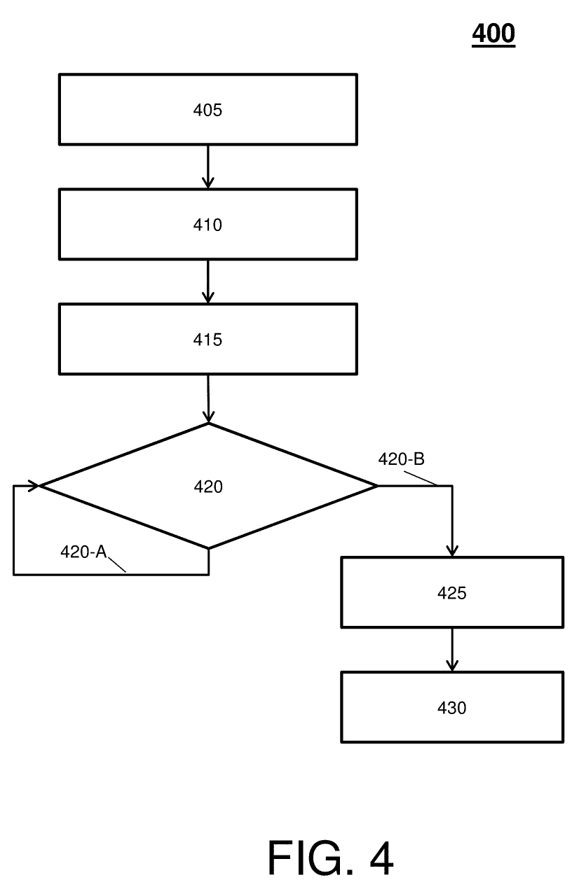

Turning now to FIG. 4, a process flow 400 executed by a brake-by-wire system (e.g., the system 300 of FIG. 3) will now be described according to an embodiment. The process flow 400, in general, is a method for operating a vehicle when required for performing service operations. In an embodiment, operating the vehicle includes enabling a “Service Mode” or a “Garage Push Mode,” which allows low speed vehicle movement so that the vehicle can be pushed into a garage or moved at very low speeds for service work on other non-related vehicle issues.

For instance, use of a unique power and/or control input to the by-wire system control module (e.g., controller 305 of the system 300) provides, independent of other vehicle communications or driver inputs, a signal for the system to enter a defined mode of operation (e.g., the garage push mode) whereby a state of health assessment is performed and, when stable operation is determined to be possible, the system is enabled to operate in a way to support specific service related needs. That is, this input provides the request to enter the service mode.

The process flow 400 begins at block 405, where a request to enter a service mode is received. The service mode is an operational state of a vehicle where vehicle controls and electrical features (e.g., braking capabilities of the system 300 of FIG. 3) are enabled or activated without other vehicular functional support (e.g., engine operation, power for operation, data communications, etc.). Thus, while the service mode is activated, the vehicle can be moved without being operational but with braking capabilities.

At block 410, system conditions are determined based on thresholds. That is, the system conducts an independent health state assessment of the vehicle by analyzing the system conditions of the vehicle. System conditions include circumstances of and surrounding the vehicle. The system conditions can be detected based on the plurality of inputs (which are also described herein), such as battery voltage, battery capacity, wheel idle, wheel/vehicle speed, system component on/off, engine revolutions per minute, ambient temperature, inertial measurements, etc. The system conditions are compared against the thresholds during the independent health state assessment to determine if the vehicle is in a stable state (e.g., the vehicle is stationary). In this way, the thresholds utilized during the health state assessment can be predefined parameters that indicate the stable state. If the vehicle is determined to be in the stable state (e.g., the system conditions meet or are within the thresholds), then the process flow 400 proceeds to block 415.

At block 415, the service mode is entered. For instance, the system is placed in the service mode to enable a limited operation that allows specific vehicle functions (e.g., low speed movement of vehicle, towing, etc.). For example, entering the service mode can include releasing a brake, such as a parking brake, and enabling other braking capabilities without engine capabilities.

At decision block 420, the system conditions are monitored against predefined parameters. For example, before and during service mode operation, the system 300 monitors vehicle status to ensure that normal vehicle operation and the service mode are mutually exclusive while overall vehicle stability (i.e. hazard mitigation) is maintained. To provide this exclusive relationship, inputs (transmission gear selection, specific vehicle communications, driver input, etc.) and outputs (warning messages, chimes, etc.) can be incorporated into the monitoring strategy to meet requirements that assure stable operation. For instance, a vehicle propulsion capability may be allowed at a severely limited speed or disabled while the service mode is active.

The predefined parameters utilized during the monitoring can indicate that a stable state is active. Providing that the system conditions meet or are within the predefined parameters, the service mode can be maintained (e.g., the process flow 400 loops back to decision block 420 via Arrow 420-A). If the system conditions are outside of the predefined parameters, the service mode can be exited (e.g., the process flow 400 proceeds to block 425 via Arrow 420-B). In addition, a request to exit the service mode can be received. This request can also cause the process flow 400 to proceed to block 425.

At block 425, the brake is applied. The brake can be the parking brake. With the parking brake engaged, the vehicle is placed in a stationary state. In turn, at block 430, the service mode is exited. For example, the vehicle is returned to an off state where it can then resume normal operations once turned on.

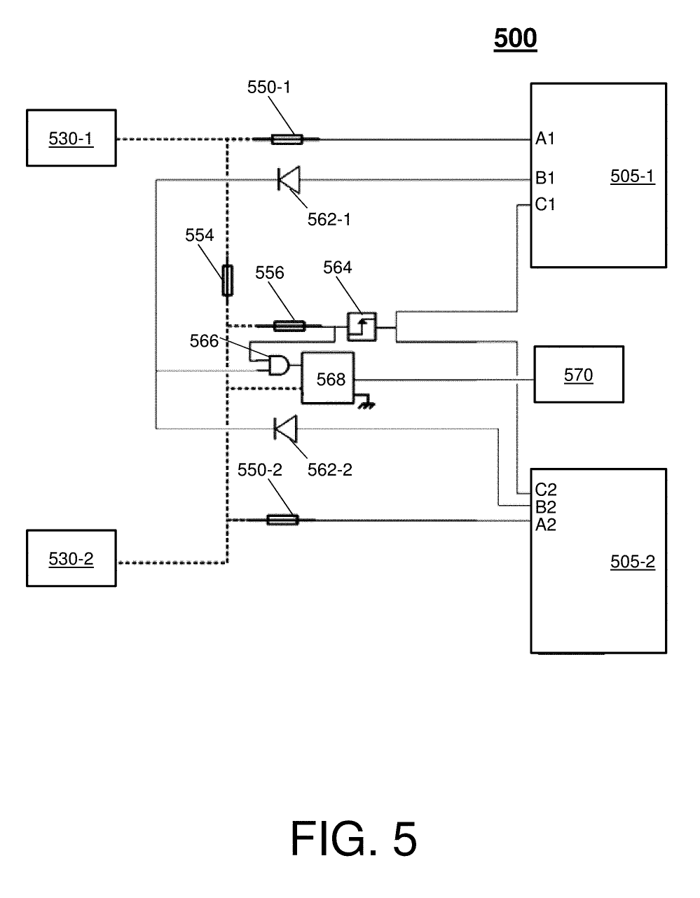

FIG. 5 is a schematic view of a service mode mechanism of a brake-by-wire system 500 in accordance with another embodiment. As illustrated, the brake-by-wire system 500 can include at least one controller 505, at least one battery 530, at least one fuse 550, 554, 556, at least one terminal electrical component 562, at least one pulse detection component 564, at least one logic gate 566, at least one indicator circuitry 568, and an indicator 570.

The controllers 505 can be a controller 205 as described herein. The batteries 530 are an example of power electronics 230 described herein. In the context of system 500, one or both of the batteries 530-1 and 530-2 can be a 12 volt battery.

The fuses 550, 554, 556 are a type of low resistance resistors that act as a sacrificial devices to provide overcurrent protection. Note that the fuse 556 can be referred to as a garage push mode fuse. Also, the garage push mode fuse 556 can be non-customer facing to implement a security feature that prevents the customer from incorrectly activating the garage push mode. The at least one terminal electrical component 562 can be a two-terminal electronic component that conducts in one direction by having a low resistance to the flow of current in the one direction and high resistance in the other (e.g., a semiconductor diode). The at least one pulse detection component 564 is a circuit that switches between two stable states based on the presence of a pulse, such as a flip-flop or latch.

The at least one logic gate 566 is a device implementing a Boolean function. As shown in FIG. 5, the logic gate 566 can be an AND gate. The logic gate 566 provides a signal to the at least one indicator circuitry 568, which in response controls the operations of the indicator 570. The at least one indicator circuitry 568 can be a controller 205 as described above. The indicator 570 can be any light or information source that is exposed to a user to indicate that the vehicle is in the garage push mode.

The items illustrated by FIG. 5 are representations and are not intended to be limiting. Thus, each component may represent a plurality of that component and/or each plurality may represent a singular iteration thereof. It should also be appreciated that the system 500 can include other components, that the system 500 can include fewer components, that the components can be embodied in separate arrangements in a distributed manner, and that the components can be embodied in an integrated control scheme. For example, the controller 505 is illustrated as a plurality of controllers 505 notated by the controller 505-1 and controller 505-2; the battery 530 is illustrated as a plurality of batteries 530 notated by battery 530-1 and battery 530-2; and the fuse 550 is illustrated as a plurality of fuses 550 notated by fuse 550-1 and fuse 550-2.

The components of the system 500 can be electronically coupled and located throughout the vehicle 100 of FIGS. 1-3, along with being configured to communicate/interact with each other. As shown in FIG. 5, signals and power wirings are identified by various lines. For example, power wirings connect the battery 530-1 through the fuse 550-1 to the controller 505-1 at contact A1, connect the battery 530-2 through the fuse 550-2 to the controller 505-2 at contact A2, and connect the battery 530-1 through the isolation fuse 554 to the indicator circuitry 568 and the garage push mode fuse 556. Further, signals/communications are outputted or inputted to/from the controllers 505 via contacts B and C.

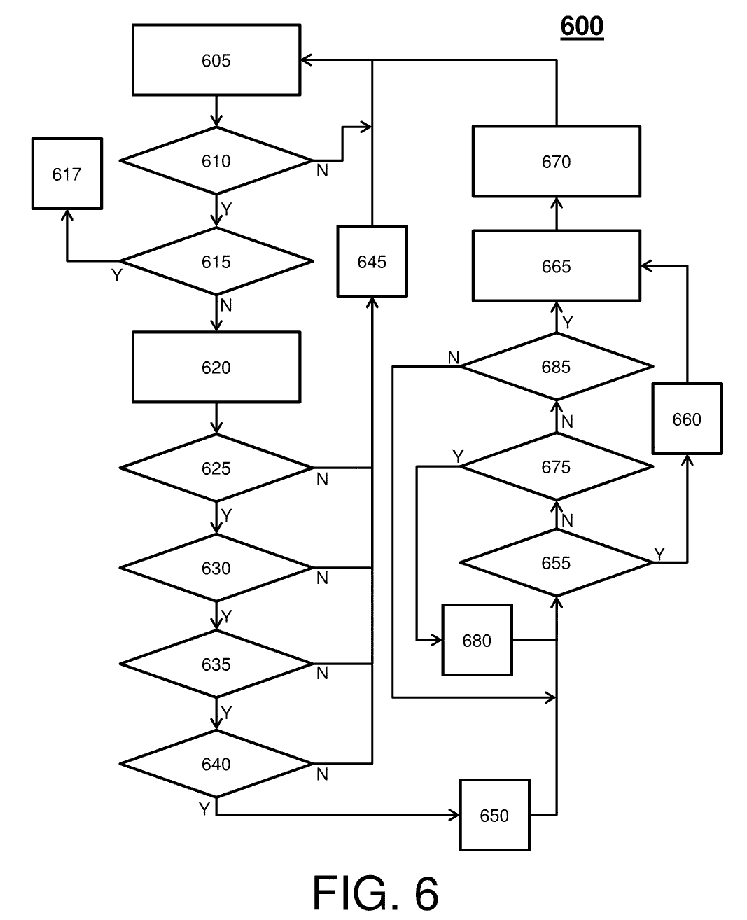

An operation of the system 500 will now be described with respect to FIG. 6. FIG. 6 is a process flow 600 executed by a brake-by-wire system 500 in accordance with another embodiment. In general, the process flow 600 enhances the ability of by-wire controls systems to allow expected service and repair procedures.

For instance, primary vehicle control subsystems (i.e., steering, brakes, etc.) employing by-wire controls may not be capable of stand-alone operations. The process flow 600 enables independent operation of by-wire vehicle control subsystems and allows low speed maneuvering of vehicles for service and maintenance usage. The functions enabled by the process flow 600 are independent of type of vehicle level fault present. The types of vehicle level faults include a 12V power fault, a control system fault, collision damage, etc. Thus, the process flow 600 determines whether the vehicle is able to move with control, and enables movement for service as needed.

The process flow 600 begins at block 605, where a vehicle begins in an off-mode. The off-mode can also be referenced to as a sleep-mode that enables the vehicle to receive start commands without the vehicle being operational. During the off-mode (and all other modes), power from the batteries 530 via the fuses 550 is supplied to the controllers 305 at contacts A so that these controllers can listen for and receive commands.

At decision block 610, the system 500 detects whether the garage push mode fuse 556 is present. The detection of the garage push mode fuse 556 is an example of receiving a request to enter a garage push mode. In an embodiment, an operator can use a deliberate manual operation (e.g. inserting the garage push mode fuse 556), to request a garage push mode of the by-wire control system (e.g., the system 500). Completing a circuit by inserting the fuse 556 into an open fuse socket will power up the vehicle in the garage push mode and send a signal to the controller that the vehicle is entering into the garage push mode.

The system 500 can detect whether the garage push mode fuse 556 is present by identifying whether a rising edge is flowing from the direction of the garage push mode fuse 556. If the garage push mode fuse 556 is not detected, the process flow 600 returns to block 605 (as shown by the ‘N’ arrow).

If the garage push mode fuse 556 is detected, the process flow 600 proceeds to decision block 615 (as shown by the ‘Y’ arrow). For example, once the garage push mode fuse 556 is placed into the system 500, power from the batteries 530 flows to the at least one pulse detection component 564. Then at least one pulse detection component 564 detects the flow of power as a pulse and changes from a first state to a second state. The second state causes a garage push signal to be communicated from the at least one pulse detection component 564 to the contacts C of the controllers 505.

At decision block 615, the system 500 determines if the vehicle is awake. That is, it can be the case where the garage push mode fuse 556 was mistakenly left in the system 500. In turn, the system 500 determines if another start command has initiated the vehicle under normal conditions (i.e., not in the garage push mode). If another start command has initiated the vehicle under normal conditions, the process flow 600 proceeds to block 617 (as shown by the ‘Y’ arrow). At block 617, the vehicle operates under normal conditions and the garage push mode is overridden.

If another start command has not initiated the vehicle under normal conditions, the process flow 600 proceeds to block 620 (as shown by the ‘N’ arrow). At block 620, the controllers 505 wake up to process the garage push signal received from the at least one pulse detection component 564 at the contacts C.

To process the garage push signal, the controllers 505 perform a state of health to determine whether stable operation is possible. As shown in FIG. 6, the process flow 600 proceeds through the decision blocks 625, 630, 635, and 640 to determine system conditions with respect to sage operational thresholds.

At block 625, the system 500 checks the power levels. For instance, if a power level of the first battery 530-1 is greater than a power threshold, then the process flow 600 proceeds to block 630. In an embodiment, if the power level of the first battery 530-1 is less than or equal to the power threshold, then the second battery 530-2 can also be checked against the power threshold. If a power level of the second battery 530-2 is greater than the power threshold, then the process flow 600 proceeds to block 630.

At block 630, the system 500 checks the wheel speed. If the wheel speeds are zero (e.g., idle and not moving), then the process flow 600 proceeds to block 635. At block 635, the system 500 checks the operability of the batteries 530, such as by performing a load test to determine that there is enough power to stably operate the vehicle in the garage push mode. If the operability of the batteries 530 is sufficient to stably operate the vehicle in the garage push mode, then the process flow 600 proceeds to block 640. At block 640, addition checks of the components of the system 500 can be performed to determine that these components are online and operational.

If the vehicle is determined not to be in the stable state (such as by any one of the above system checks failing), then the process flow 600 proceeds to block 645 (e.g., as shown by the ‘N’ arrows leading from the decision blocks 625, 630, 635, and 640 to block 645). At block 650, the controllers 505 are put into a sleep mode and the process flow 600 returns to the detecting whether the garage push mode fuse 556 is present (e.g., blocks 605 and 610).

If the vehicle is determined to be in the stable state (e.g., the system conditions meet or are within the thresholds as defined in the decision blocks 625, 630, 635, and 640), then the process flow 600 proceeds to block 650. At block 650, the garage push mode is entered. In the garage push mode, vehicle controls and electrical features (e.g., braking capabilities of the system 500) are enabled without the support of other vehicular functions (e.g., engine operation, power for operation, data communications, etc.).

Upon entering the garage push mode, at least one of the controllers 505 can send a signal from the contact B to turn on the indicator 570. In an embodiment, the controller 5050-1 sends a signal through the diode 562-1 to the logic gate 566. This signal is prevented from traveling to the controller 505-2 by the diode 562-2. This signal is processed with a power signal the fuse 556 to turn on the indicator circuitry 568. Once on, the indicator circuitry 568 can activate the indicator 570 to notify the operator that the garage push mode is active.

The process flow 600 proceeds to monitor the system conditions against predefined parameters. For example, the system 500 monitors vehicle status to ensure that normal vehicle operation and the garage push mode are mutually exclusive and overall vehicle stability (i.e. hazard mitigation) is maintained. To monitor the system conditions, the system 500 checks the operability of the batteries 530 at block 655.

If the power level of the first battery 530-1 is less than or equal to a predefined power parameter, then the process flow 600 proceeds to block 660 (as indicated by the ‘Y’ arrow). In an embodiment, if the power level of the first battery 530-1 is less than or equal to the predefined power parameter, then the second battery 530-2 can also be checked against the predefined power parameters. If the power level of the second battery 530-2 is less than or equal to the predefined power parameter, then the process flow 600 proceeds to block 660. At block 660, the system 600 applies the brakes to stop the vehicle and signals the indicator 570 (enables flashing). The process flow 600 proceeds to block 665.

At block 665, the brake is applied. The brake can be the parking brake. With the parking brake engaged, the vehicle is placed in a stationary state. In turn, at block 670, the garage push mode is deactivated and the indicator 570 is turned off. In an embodiment, upon deactivating the garage push mode, the controller 505-1 sends the awake signal through the diode 562-1 to the logic gate 566. This signal can be processed (used in an AND operation by the logic gate 566 with the power signal from the fuse 556) to turn off the indicator circuitry 568 and, in turn, the indicator 570.

If the power level of the first battery 530-1 is greater than the predefined power parameter, then the process flow 600 proceeds to block 675 (as indicated by the ‘N’ arrow). At block 675, the system 500 checks a vehicle speed (to determine if the vehicle is moving uncontrollably). If the vehicle speed is greater than the predefined speed parameter, then the process flow 600 proceeds to block 680 (as indicated by the ‘Y’ arrow). At block 680, the brakes are applied to limit the vehicle speed or movement. If the vehicle speed is not greater than the predefined speed parameter, then the process flow 600 proceeds to block 685 (as indicated by the ‘N’ arrow). At block 685, the system 500 checks the wheel speed against a counter. If the wheel speeds are zero for a prolonged period of time (e.g., idle and not moving), then the process flow 600 proceeds to block 665. If the wheel speeds are not zero within the prolonged period of time (e.g., the vehicle is being moved), then the process flow 600 loops back to block 655.

Embodiments herein provide advantages in increased customer satisfaction by enabling vehicle maintenance and service to be handled in similar way to conventional vehicles, which minimize learning and expenses required for developing new servicing procedures; increase efficiency of service operations by not prescribing excessively restrictive procedures or tool requirements; and enabling operation during partial battery loss or full vehicle shorted to ground failure modes.

Aspects of embodiments herein are described with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the operations/acts specified in the flowchart and/or block diagram block or blocks. These computer readable program instructions may also be stored in a computer readable storage medium that can direct a computer, a programmable data processing apparatus, and/or other devices to operate in a particular manner, such that the computer readable storage medium having instructions stored therein comprises an article of manufacture including instructions which implement aspects of the operation/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the operations/acts specified in the flowchart and/or block diagram block or blocks.

The flowchart and block diagrams in the FIGS. illustrate the architecture, operability, and operation of possible implementations of systems, methods, and computer program products according to various embodiments. In this regard, each block in the flowchart or block diagrams may represent a module, segment, or portion of instructions, which comprises one or more executable instructions for implementing the specified logical operation(s). In some alternative implementations, the operations noted in the block may occur out of the order noted in the FIGS. For example, two blocks shown in succession may, in fact, be executed substantially concurrently, or the blocks may sometimes be executed in the reverse order, depending upon the operability involved. It will also be noted that each block of the block diagrams and/or flowchart illustration, and combinations of blocks in the block diagrams and/or flowchart illustration, can be implemented by special purpose hardware-based systems that perform the specified operations or acts or carry out combinations of special purpose hardware and computer instructions.

The flow diagrams depicted herein are just one example. There may be many variations to this diagram or the steps (or operations) described therein without departing from the spirit of the disclosed. For instance, the steps may be performed in a differing order or steps may be added, deleted or modified. All of these variations are considered a part of the claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A vehicle system of a vehicle, the vehicle system comprising:
a brake-by-wire sub-system comprising a controller configured to:
receive a request to enter a service mode;
in response to the request to enter the service mode, determine whether a vehicle is in a stable state based on comparing at least one system condition against at least one threshold;
cause the brake-by-wire sub-system to enter into the service mode when the vehicle is in the stable state; and
monitoring the at least one system condition against predefined parameters to determine that the vehicle is maintaining the stable state while in the service mode.

2. The vehicle system of claim 1, wherein the service mode is an operational state where braking capabilities of the brake-by-wire sub-system are activated without other vehicle system support.

3. The vehicle system of claim 1, wherein the request is generated by the insertion of a fuse into the vehicle system.

4. The vehicle system of claim 1, wherein the vehicle system conducts an independent health state assessment of the vehicle by analyzing the at least one system condition of the vehicle.

5. The vehicle system of claim 1, wherein the at least one system condition indicates circumstances of and surrounding the vehicle.

6. The vehicle system of claim 1, wherein the at least one system condition is detected based on a plurality of inputs, the plurality of inputs comprising a battery voltage and a wheel speed.

7. The vehicle system of claim 1, wherein the controller is configured to:
cause the vehicle system to exit the service mode when the monitoring of the at least one system condition against predefined parameters determines that the vehicle is not in the stable state.

8. The vehicle system of claim 1, wherein the controller is configured to:
cause the vehicle system to exit the service mode in response to a request to exit the service mode.

9. The vehicle system of claim 1, wherein the controller is configured to:
cause the vehicle system to engage a brake to place the vehicle in a stationary state upon exiting the service mode.

10. The vehicle system of claim 1, wherein the vehicle is an automobile.

11. A method by a controller of a brake-by-wire sub-system of a vehicle, the method comprising:
receiving a request to enter a service mode;
in response to the request to enter the service mode, determining whether a vehicle is in a stable state based on comparing at least one system condition against at least one threshold;
causing the vehicle to enter into the service mode when the vehicle is in the stable state; and
monitoring the at least one system condition against predefined parameters to determine that the vehicle is maintaining the stable state while in the service mode.

12. The method of claim 11, wherein the service mode is an operational state where braking capabilities of the brake-by-wire sub-system are activated without other vehicle support.

13. The method of claim 11, wherein the request is generated by the insertion of a fuse into the vehicle.

14. The method of claim 11, wherein the comparing of the at least one system condition against at least one threshold comprises conducting an independent health state assessment of the vehicle by analyzing a plurality of system conditions of the vehicle.

15. The method of claim 11, wherein the at least one system condition indicates circumstances of and surrounding the vehicle.

16. The method of claim 11, wherein the at least one system condition is detected based on a plurality of inputs, the plurality of inputs comprising a battery voltage and a wheel speed.

17. The method of claim 11, further comprising:
exiting the service mode when the monitoring of the at least one system condition against predefined parameters determines that the vehicle is not in the stable state.

18. The method of claim 11, further comprising:
exiting the service mode in response to a request to exit the service mode.

19. The method of claim 11, further comprising:
engaging a brake to place the vehicle in a stationary state upon exiting the service mode.

20. The method of claim 11, wherein the vehicle is an automobile.
